(19) United States
(12) Patent Application Publication
(10) Pub. No.: US 2026/0316488 A1
(43) Pub. Date: Oct. 15, 2026

(54) PAINT TRAY

(71) Applicant: Corey Wayne Moscaluk, Big White Mountain (CA)

(72) Inventor: Corey Wayne Moscaluk, Big White Mountain (CA)

(21) Appl. No.: 19/176,582

(22) Filed: Apr. 11, 2025

(51) Int. Cl. B44D 3/12

(52) U.S. Cl. CPC B44D 3/126

(57) ABSTRACT

A paint tray that is configured to protect paint disposed therein from sun and debris so as to avoid deterioration or compromise of the paint during a coating application. The tray includes a lower tray member having a plurality of walls and a bottom integrally formed to create an interior volume. The interior volume of the lower tray is configured to receive and store paint or coating material therein. The lower tray member has operably coupled thereto a cover member. The cover member includes opposing sidewalls and a top wall that form an opening wherein the opening provides access to the interior volume of the lower tray member. The cover member is releasably secured to the lower tray member utilizing engagement members formed on the opposing sidewalls of the cover member. The sidewalls of the cover member are triangular in shape.

### FIELD OF THE INVENTION

The present invention relates generally to painting equipment, more specifically but not by way of limitation, a paint tray designed to accommodate paint therein and be utilized with a roller brush wherein the present invention includes a cover member secured over the top of the paint tray having an opening allowing access to the paint with a roller brush while providing protection of the paint from sun and debris.

### BACKGROUND

Painting outdoors presents unique challenges that can significantly impact the quality and efficiency of a painting project. While painting in natural light can enhance visibility and allow for better color accuracy, using a traditional paint tray in an outdoor setting introduces several complications. Among these challenges, exposure to direct sunlight and environmental debris are two primary issues that can negatively affect the paint's consistency and overall application. Developing a covered paint tray offers a practical solution to mitigate these difficulties and improve the painting experience. One of the most significant challenges of using a paint tray outdoors is the impact of direct sunlight. When exposed to the sun, paint in an open tray can dry at an accelerated rate. This rapid drying can lead to uneven application, as the paint thickens or forms a skin on the surface before it is applied to the painting surface. Additionally, prolonged exposure to sunlight can alter the chemical composition of the paint, particularly water-based and latex paints, causing them to lose their intended texture and finish. The increased drying speed also results in more frequent refills, leading to wasted paint and higher costs for the project.

In addition to sunlight, another major challenge when using a paint tray outdoors is contamination from environmental debris. Outdoor environments are filled with dust, leaves, insects, and other airborne particles that can easily fall into an uncovered paint tray. These contaminants can mix with the paint, resulting in an uneven texture and affecting the final appearance of the painted surface. Removing debris from the tray is time-consuming and often requires additional filtration or cleaning processes, further delaying the painting task. Moreover, once debris becomes embedded in the paint, it can lead to imperfections in the finish, reducing the overall quality of the project. Given these challenges, the development of a covered paint tray presents a significant advantage for outdoor painters. A covered paint tray would serve as a protective barrier against both rapid drying due to sunlight and contamination from airborne debris. By shielding the paint from direct exposure, a cover can help maintain its optimal consistency for a longer period, reducing waste and ensuring a smoother application. Additionally, a covered tray can minimize interruptions caused by the need to clean out debris, allowing painters to work more efficiently and with fewer frustrations.

Furthermore, a well-designed covered paint tray could incorporate features such as adjustable openings for easy brush or roller access while still limiting exposure to the elements. Some designs might include a transparent lid to monitor paint levels without opening the tray, or even insulation properties to further regulate temperature and prevent excessive drying. These enhancements would make outdoor painting more manageable and professional, improving both the process and the final outcome. Painting outside with a traditional open paint tray presents considerable challenges, primarily due to the negative effects of sunlight and environmental debris. These issues can lead to rapid drying, increased waste, and compromised paint quality. However, by developing and utilizing a covered paint tray, painters can protect their materials, reduce unnecessary interruptions, and enhance the efficiency of their work. As outdoor painting continues to be a popular practice, investing in practical solutions such as a covered paint tray can greatly improve the overall painting experience and the final results.

Accordingly, there is a need for a paint tray that has a cover member yet permits access to the paint tray with a roller brush wherein the cover member protects the paint disposed in the paint tray from sun and debris.

### SUMMARY OF THE INVENTION

It is the object of the present invention to provide a paint tray that is configured to protect paint disposed therein wherein the present invention includes a lower tray member having a bottom integrally formed with walls to create an interior volume.

Another object of the present invention is to provide a paint tray that will inhibit sun and debris from contacting the paint disposed in the paint tray that further includes a cover member.

A further object of the present invention is to provide a paint tray that is configured to protect paint disposed therein wherein the cover member is releasably superposed the lower tray member.

Yet a further object of the present invention is to provide a paint tray that will inhibit sun and debris from contacting the paint disposed in the paint tray wherein the cover member includes an opening capable of accommodating a roller brush therethrough.

Still another object of the present invention is to provide a paint tray that is configured to protect paint disposed therein wherein the cover member is tapered in form having opposing side walls and a top.

An additional object of the present invention is to provide a paint tray that will inhibit sun and debris from contacting the paint disposed in the paint tray wherein the cover member could be configured with a movable top member.

Yet a further object of the present invention is to provide a paint tray that is configured to protect paint disposed therein wherein the sidewalls of the cover member include clip members formed on the lower edge thereof.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of the present invention with the cover member separated from the lower tray member; and

FIG. 2 is a front perspective view of the present invention with the cover member separated from the lower tray member.

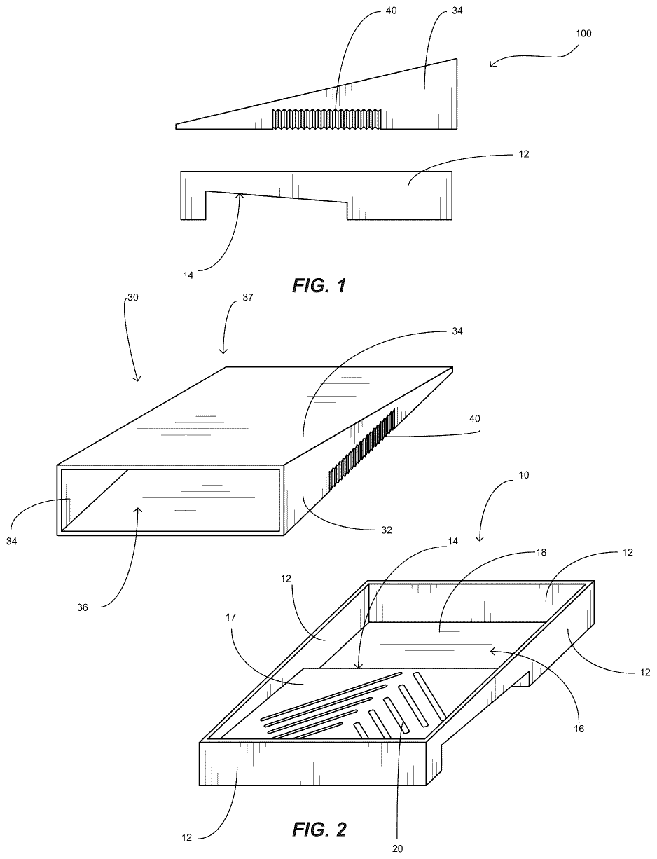

### DETAILED DESCRIPTION

Referring now to the drawings submitted herewith, wherein various elements depicted therein are not necessarily drawn to scale and wherein through the views and figures like elements are referenced with identical reference numerals, there is illustrated a paint tray 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the paint tray 100 is configured to protect paint disposed therein from elements such as but not limited to sun and debris. It should be understood within the scope of the present invention that the paint tray 100 could be manufactured in alternate sizes and further be provided in alternate shapes in addition to the preferred embodiment illustrated herein. The paint tray 100 is manufactured utilizing suitable techniques from materials such as but not limited to plastic or metal.

The paint tray 100 includes a lower tray member 10 that is configured to receive and store paint or similar coating material therein. The lower tray member 10 includes a plurality of walls 12 formed with a bottom 14 that are integrally formed to create an interior volume 16. The bottom 14 includes a first portion 17 contiguous with a second portion 18 wherein the first portion 17 tapers downward towards the second portion 18 creating a larger interior volume 16 proximate the second portion 18. The first portion 17 of the bottom 14 includes ridge members 20 that are formed on the surface of the first portion 17 and extend upward therefrom. Ridge members 20 are employed to assist in removing excess paint from a conventional roller brush.

Releasably secured to the lower tray member 10 is cover member 30. Cover member 30 is manufactured from a lightweight rigid material such as but not limited to plastic. The cover member 30 includes opposing sidewalls 32,34 integrally formed with a top wall 34. The opposing sidewalls 32,34 and top wall 34 form an opening 36 wherein the opening 36 provides access to the interior volume 16 of the lower tray member 10. The opening 36 is sized so as to accommodate a conventional roller brush therethrough. The opposing sidewalls 32,34 are formed in a triangular shape having a height proximate the opening 36 that is greater than that of the height proximate the second end 37 of the cover member 30 distal to the opening 36. As the second portion 18 of the bottom 14 is lower than that of the first portion 17, the shape of the cover member 30 accommodates a conventional roller brush while maintaining a suitable coverage of the paint disposed within the paint tray 100 providing protection thereof.

Formed on the lower edge 39 of the sidewalls 32,34 are engagement members 40. Engagement members 40 are configured to facilitate the releasable securing of the cover member 30 to the lower tray member 10. The engagement members 40 are corrugated in form so as to provide a frictional engagement with the walls 12 on the opposing sides of the lower tray member 10. The engagement members 40 extend approximately fifty percent of the length of the sidewalls 32,34. While a particular style of engagement members 40 have been illustrated and discussed herein, it is contemplated within the scope of the present invention that the engagement members 40 could be formed in numerous alternate manners and employ elements such as but not limited to mechanical fasteners to facilitate the releasable securing of the cover member 30 to the lower tray member 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A paint tray configured to protect coating material disposed therein wherein the paint tray comprises:
a lower tray member, said lower tray member having a plurality of walls and a bottom forming an interior volume, said bottom having a first portion and a second portion, said bottom being tapered from said first portion to said second portion wherein the interior volume is greater proximate said second portion;
a cover member, said cover member having opposing sidewalls integrally formed with a top wall, cover member having a first end and a second end, said cover member having an opening proximate said first end, said opening providing access to said interior volume of said lower tray member, said opposing sidewalls having a height proximate said second end of said cover member that is less than that of a height proximate said first end.

2. The paint tray configured to protect coating material disposed therein as recited in claim 1, and further including engagement members, said engagement members being configured to releasably secure said cover member to said lower tray member.

3. The paint tray configured to protect coating material disposed therein as recited in claim 2, wherein said engagement members are formed on said opposing sidewalls along a lower edge thereof.

4. The paint tray configured to protect coating material disposed therein as recited in claim 3, wherein said opposing sidewalls are triangular in shape tapering downward towards said second end of said cover member.

5. The paint tray configured to protect coating material disposed therein as recited in claim 4, wherein said engagement members are integrally formed in said opposing sidewalls and are corrugated in form.

6. The paint tray configured to protect coating material disposed therein as recited in claim 5, wherein said opening of said cover member is sized to accommodate a roller brush therethrough.
